(19) United States
(12) Patent Application Publication
(10) Pub. No.: US 2013/0034052 A1
(43) Pub. Date: Feb. 7, 2013

(54) MOBILE COMMUNICATION APPARATUS AND RADIO COMMUNICATION METHOD

(71) Applicant: Naritoshi SAITO, Hino (JP)

(72) Inventor: Naritoshi SAITO, Hino (JP)

(73) Assignee: FUJITSU TOSHIBA MOBILE COMMUNICATIONS LIMITED, Kawasaki-shi (JP)

(21) Appl. No.: 13/559,763

(22) Filed: Jul. 27, 2012

(30) Foreign Application Priority Data
Aug. 3, 2011 (JP) 2011-170041

(51) Int. Cl. H04W 4/00

(52) U.S. Cl. 370/328

(57) ABSTRACT

A mobile communication apparatus can perform data communication by the use of a first radio access network and a second radio access network. When a receiving section detects during time for which a processor is in a suspend state that the mobile communication apparatus moves out of a coverage area of the first radio access network, the receiving section releases the suspend state of the processor. When the suspend state of the processor is released as a result of detecting that the mobile communication apparatus moves out of the coverage area of the first radio access network, the control section establishes a connection to the second radio access network by the use of the processor.

### CROSS-REFERENCE TO RELATED APPLICATION

This application is based upon and claims the benefit of priority of the prior Japanese Patent Application No. 2011-170041, filed on Aug. 3, 2011, the entire contents of which are incorporated herein by reference.

### FIELD

The embodiments discussed herein are related to a mobile communication apparatus and a radio communication method.

### BACKGROUND

At present radio communication systems such as mobile phone systems and radio LANs (Local Area Networks) are widely used. There are plural kinds of radio access networks, such as a CDMA (Code Division Multiple Access)2000 1x network, a CDMA2000 EVDO (Evolution Data Only) network, and a WiMAX network, which can be used by a mobile communication apparatus and which differ in communication scheme. With CDMA2000 1x networks and CDMA2000 EVDO networks, CDMA is used as a multiple access scheme. With WiMAX networks, OFDMA (Orthogonal Frequency Division Multiple Access) is used as a multiple access scheme. There are mobile communication apparatus which can use plural kinds of radio access networks.

For example, a radio communication terminal which can use a mobile phone system and a radio LAN and which reduces power consumption in a coverage area of a radio LAN in the following way is proposed. When the radio communication terminal detects that it has moved into the coverage area of the radio LAN, it inquires of a user whether to turn off its mobile phone function. In addition, a radio communication terminal which can perform diversity communication by the use of a plurality of radio communication systems and which reduces power consumption in the following way is proposed. When the degree of access channel regulation in a base station is high, the radio communication terminal stops its diversity operation.
Japanese Laid-open Patent Publication No. 2005-295532
Japanese Laid-open Patent Publication No. 2008-167079

By the way, a mobile communication apparatus may use a processor for data communication control or user interface control. When an event, such as data communication or operation by a user, does not occur for a certain period of time, the processor may shift to a suspend state in which the power consumption is low. For example, when the processor is in the suspend state, the processor stops executing an application program or a driver program and waits for an event to occur. When the processor detects the occurrence of an event, the processor returns to an active state.

On the other hand, when there is data to be transmitted from a network side to a mobile communication apparatus, the mobile communication apparatus receives paging regarding data communication. If the mobile communication apparatus can use two or more radio access networks for data communication, then paging information is transmitted by the use of a radio access network in which a data channel is currently set. After data communication is performed by the use of a radio access network, a data channel remains set in the radio access network. It is assumed that the mobile communication apparatus moves out of a coverage area of the radio access network. Even if the mobile communication apparatus is in a coverage area of a second radio access network, paging information is not transferred to the second radio access network in the case of nothing being done. That is to say, the mobile communication apparatus cannot receive paging.

### SUMMARY

According to an aspect of the invention, there is provided a mobile communication apparatus which is capable of performing data communication by use of a first radio access network and a second radio access network, including a receiving section which processes a signal received from the first radio access network and a control section including a processor which is capable of shifting to a suspend state, the receiving section releasing the suspend state of the processor at the time of detecting during time for which the processor is in the suspend state that the mobile communication apparatus moves out of a coverage area of the first radio access network, the control section establishing a connection to the second radio access network by use of the processor at the time of the suspend state of the processor being released as a result of detecting that the mobile communication apparatus moves out of the coverage area of the first radio access network.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a mobile communication apparatus according to a first embodiment;

FIG. 2 illustrates a mobile telecommunication system according to a second embodiment;

FIG. 3 is an example of a coverage area of a radio access network;

FIG. 4 is an example of a physical channel in a radio access network;

FIG. 5 is an example of a physical channel in another radio access network;

FIG. 6 is an example of timing at which a paging channel is received;

FIG. 7 is an example of an out-of-coverage-area search;

FIG. 8 is a block diagram of an example of the hardware of a mobile station;

FIG. 9 is a block diagram on radio transmission and receiving;

FIG. 10 is a block diagram on a CPU interrupt;

FIG. 11 is a block diagram of an example of software executed by a control section;

FIG. 12 is an example of the transition of a data communication state;

FIG. 13 is a flow chart of an example of wait by a mobile station (part 1);

FIG. 14 is a flow chart of an example of wait by a mobile station (part 2);

FIG. 15 is a sequence diagram of an example of making a connection to a radio access network (part 1);

FIG. 16 is a sequence diagram of an example of making a connection to a radio access network (part 2);

FIG. 17 is a sequence diagram of an example of receiving a paging channel;

FIG. 18 is a sequence diagram of an example of making a connection to another radio access network;

FIG. 19 is a sequence diagram of an example of a PPP connection; and

FIG. 20 is a sequence diagram of an example of receiving another paging channel.

### DESCRIPTION OF EMBODIMENTS

Embodiments will now be described with reference to the accompanying drawings, wherein like reference numerals refer to like elements throughout.

### First Embodiment

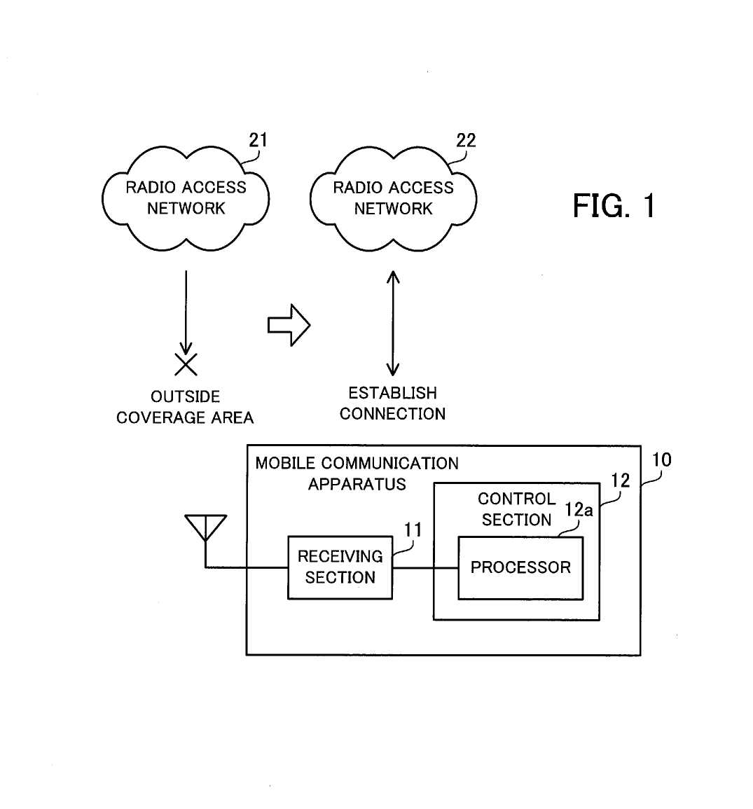

FIG. 1 illustrates a mobile communication apparatus according to a first embodiment.

A mobile communication apparatus 10 performs data communication (such as packet communication) by the use of radio access networks 21 and 22. It can be said that the mobile communication apparatus 10 can operate in dual mode or multimode with respect to data communication. The mobile communication apparatus 10 is a radio terminal device such as a portable telephone (which may be a device referred to as a smart phone) or a personal digital assistant.

Each of the radio access networks 21 and 22 includes a base station for transmitting a radio signal. The radio access networks 21 and 22 may differ from each other in radio communication scheme. For example, the radio access network 21 may be an EVDO network, a W-CDMA (Wideband Code Division Multiple Access) network, or the like using CDMA. The radio access network 22 may be a WiMAX network, an LTE (Long Term Evolution) network, an LTE-A (Long Term Evolution Advanced) network, or the like using OFDMA. Furthermore, the radio access networks 21 and 22 may differ in extent of coverage area. For example, a coverage area of the radio access network 21 may be smaller than a coverage area of the radio access network 22.

The mobile communication apparatus 10 includes a receiving section 11 and a control section 12.

The receiving section 11 processes a signal received from the radio access network 21. This received signal processing includes, for example, timing synchronization, a base station search, and detecting a paging channel which is a radio channel. Paging information regarding data communication a destination of which is the mobile communication apparatus 10 may be transmitted by the use of the paging channel.

The control section 12 controls data communication performed by the use of the radio access networks 21 and 22. The control section 12 includes a processor 12a. The processor 12a is, for example, an operation unit, such as a CPU (Central Processing Unit), which executes a program. The control section 12 may also include a memory such as a RAM (Random Access Memory).

When an event, such as data communication or operation by a user, does not occur for a certain period of time, the processor 12a shifts to a suspend state in which the power consumption is low. When the processor 12a is in the suspend state, the processor 12a stops executing an application program or a driver program and waits for an event to occur. When the processor 12a detects the occurrence of an event, the processor 12a returns to an active state. For example, an interrupt signal is inputted to the processor 12a at the time of the occurrence of an event. The processor 12a receives the interrupt signal and shifts from the suspend state to the active state. For example, GPIO (General Purpose Input/Output) is used for transmitting the interrupt signal.

When the processor 12a is in the suspend state and a data channel is set in the radio access network 21, the receiving section 11 continuously receives a paging channel from the radio access network 21. When the processor 12a shifts to the suspend state after data communication performed by the use of the radio access network 21, a data channel remains set in the radio access network 21. Furthermore, while the processor 12a is in the suspend state, the receiving section 11 watches on the basis of conditions (such as a receiving power level and receiving quality) under which a radio signal is received from the radio access network 21 whether or not the mobile communication apparatus 10 is in the coverage area of the radio access network 21. When the receiving section 11 detects that the mobile communication apparatus 10 moves out of the coverage area of the radio access network 21, the receiving section 11 releases the suspend state of the processor 12a. For example, the receiving section 11 outputs an interrupt signal to the processor 12a.

When the receiving section 11 detects that the mobile communication apparatus 10 moves out of the coverage area of the radio access network 21, the receiving section 11 releases the suspend state of the processor 12a. At this time the control section 12 establishes a connection to the radio access network 22 by the use of the processor 12a. This connection may be a PPP (Point-to-Point Protocol) connection. As a result, a data channel switches from the radio access network 21 to the radio access network 22. After the receiving section 11 detects that the mobile communication apparatus 10 moves out of the coverage area of the radio access network 21, the control section 12 may make the receiving section 11 stop processing a received signal or make the receiving section 11 continue to make a search for a base station in the radio access network 21. After a connection is established to the radio access network 22, the processor 12a may shift to the suspend state.

With the mobile communication apparatus 10 according to the first embodiment the processor 12a shifts to the suspend state at the time of data communication not being performed. When the receiving section 11 detects on the basis of conditions under which a signal is received from the radio access network 21 that the mobile communication apparatus 10 moves out of the coverage area of the radio access network 21, the suspend state of the processor 12a is released. When the suspend state of the processor 12a is released in this way, the processor 12a is then used for establishing a connection to the radio access network 22.

As a result, even if the mobile communication apparatus 10 moves out of the coverage area of the radio access network 21 at the time of the processor 12a being in the suspend state, a data channel set in the radio access network 21 can be switched to the radio access network 22. This prevents a data channel from remaining set in the radio access network 21. Accordingly, the mobile communication apparatus 10 can receive from the radio access network 22 paging information regarding data communication a destination of which is the mobile communication apparatus 10. A data channel may be set exclusively in one of the radio access networks 21 and 22.

In the following second embodiment a case where data communication is performed by the use of an EVDO network and a WiMAX network is taken as an example. However, a communication control method described in the second embodiment may be applied to another kind of radio access network such as a W-CDMA network, an LTE network, or an LTE-A network.

### Second Embodiment

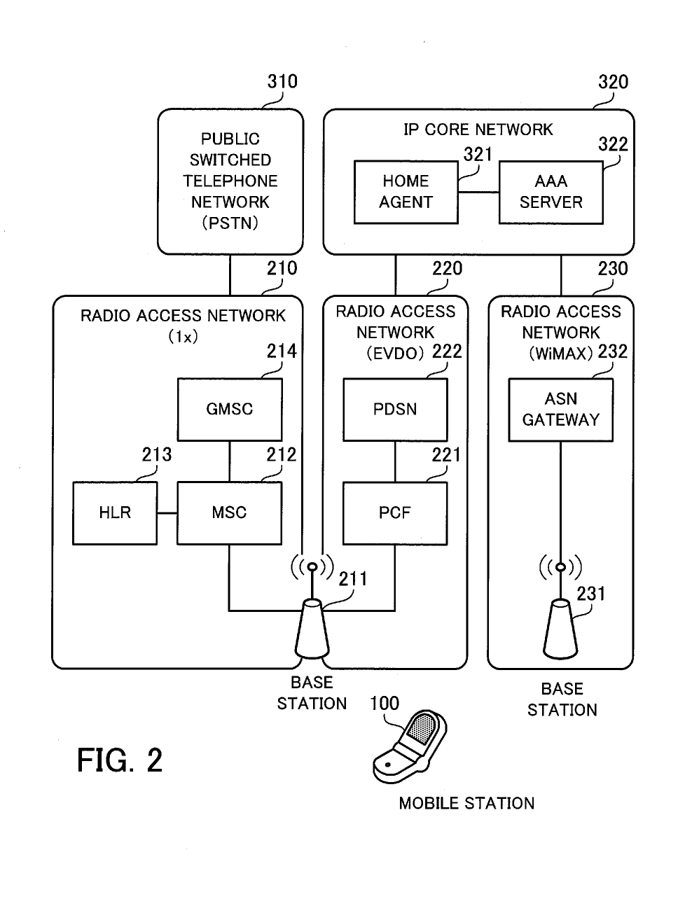

FIG. 2 illustrates a mobile telecommunication system according to a second embodiment. A mobile telecommunication system includes a mobile station 100, radio access networks 210, 220, and 230, a PSTN (Public Switched Telephone Network) 310, and an IP core network 320.

The mobile station 100 is a radio terminal device such as a portable telephone or a personal digital assistant. The mobile station 100 can perform radio communication by the use of three communication schemes, that is to say, CDMA2000 1x, CDMA2000 EVDO, and WiMAX. The mobile station 100 uses CDMA2000 1x for performing audio communication and uses CDMA2000 EVDO or WiMAX for performing data communication.

The radio access network 210 is a network which uses CDMA2000 1x for performing radio communication with the mobile station 100 and which transmits an audio signal by a line switching system. The radio access network 210 is connected to the PSTN 310. The radio access network 210 includes a plurality of base stations including a base station 211, an MSC (Mobile Switching Center) 212, an HLR (Home Location Register) 213, and a GMSC (Gateway Mobile Switching Center) 214. Each base station forms a cell and a coverage area of the radio access network 210 is formed of a group of cells.

The base station 211 is a communication apparatus which performs radio communication with the mobile station 100 and which performs wired communication with the MSC 212. The base station 211 transfers an audio signal between the mobile station 100 and the MSC 212. The MSC 212 is a switching system connected to the base station 211 and the GMSC 214. The MSC 212 establishes a connection to the mobile station 100 via the base station 211 and processes an audio signal. The HLR 213 manages a subscriber information database. Subscriber information is referred to by the MSC 212 and is used for controlling audio communication. The GMSC 214 is a gateway device connected to the PSTN 210, and transfers an audio signal.

The radio access network 220 is a network which uses CDMA2000 EVDO for performing radio communication with the mobile station 100 and which transmits data by a packet switching system. The radio access network 220 is connected to the IP core network 320. The radio access network 220 includes the plurality of base stations shared by the radio access network 210, a PCF (Packet Control Function) 221, and a PDSN (Packet Data Serving Node) 222. Each base station forms a cell and a coverage area of the radio access network 220 is formed of a group of cells. In the example of FIG. 2, the base station 211 belongs both to the radio access network 210 and to the radio access network 220. However, base stations for the radio access network 210 and base stations for the radio access network 220 may be separated.

The base station 211 performs radio communication with the mobile station 100 and performs wired communication with the PCF 221. The base station 211 transfers data in a packet format between the mobile station 100 and the PCF 221. The PCF 221 is connected to the base station 211 and the PDSN 222 and transfers data in the packet format. The PDSN 222 is a gateway device connected to the IP core network 320. The PDSN 222 establishes a PPP connection to the mobile station 100 via the base station 211 and the PCF 221 and transfers data in the packet format.

The radio access network 230 is a network which uses WiMAX for performing radio communication with the mobile station 100 and which transmits data by the packet switching system. The radio access network 230 is connected to the IP core network 320. The radio access network 230 includes a plurality of base stations including a base station 231 and an ASN (Access Service Network) gateway 232. Each base station forms a cell and a coverage area of the radio access network 230 is formed of a group of cells.

The base station 231 is a communication apparatus which performs radio communication with the mobile station 100 and which performs wired communication with the ASN gateway 232. The base station 231 transfers data in the packet format between the mobile station 100 and the ASN gateway 232. The ASN gateway 232 is a gateway device connected to the IP core network 320, and transfers data in the packet format.

The PSTN 310 is a telephone network which transmits an audio signal by the line switching system, and includes a switching system. The PSTN 310 can also be used by a fixed-line telephone. An ISDN (Integrated Service Digital Network) may be used in place of the PSTN 310.

The IP core network 320 is an IP network which controls data communication performed by the mobile station 100 and which transmits data by the packet switching system. The IP core network 320 is connected to the radio access networks 220 and 230. The IP core network 320 includes an HA (Home Agent) 321 and an AAA (Authentication, Authorization and Accounting) server 322.

The HA 321 is a communication apparatus in which the mobile station 100 connected to the radio access network 220 or 230 is registered and which transfers data a destination of which is the mobile station 100 on the basis of registered information. The HA 321 checks which of the radio access networks 220 and 230 the mobile station 100 uses for performing data communication, and transfers data a destination of which is the mobile station 100 to the PDSN 222 or the ASN gateway 232. The AAA server 322 is a server apparatus which performs authentication of the mobile station 100 or accounting on a user of the mobile station 100.

The mobile station 100 selects one of the radio access networks 220 and 230 and performs data communication. A data channel is set exclusively in one of the radio access networks 220 and 230. When the mobile station 100 establishes a PPP connection to the radio access network 220, the mobile station 100 and the IP core network 320 recognize that a data channel is set in the radio access network 220 and that the radio access network 230 is in an unused state. On the other hand, when the mobile station 100 makes a connection to the radio access network 230 (performs an entry procedure), the mobile station 100 and the IP core network 320 recognize that the data channel is switched to the radio access network 230 and that the PPP connection to the radio access network 220 becomes invalid.

While the mobile station 100 is not performing data communication, data to be transmitted from the IP core network 320 to the mobile station 100 may be generated. At this time paging information is transmitted to the mobile station 100 from one of the radio access networks 220 and 230 in which a data channel is set. When a PPP connection is established to the radio access network 220, the base station 211 radio-transmits paging information to the mobile station 100. On the other hand, when the mobile station 100 makes a connection to the radio access network 230 and does not establish a PPP connection to the radio access network 220, the base station 231 radio-transmits paging information to the mobile station 100.

The mobile station 100 is an example of the mobile communication apparatus 10 according to the first embodiment. The radio access network 230 is an example of the radio access network 21 in the first embodiment. The radio access network 220 is an example of the radio access network 22 in the first embodiment.

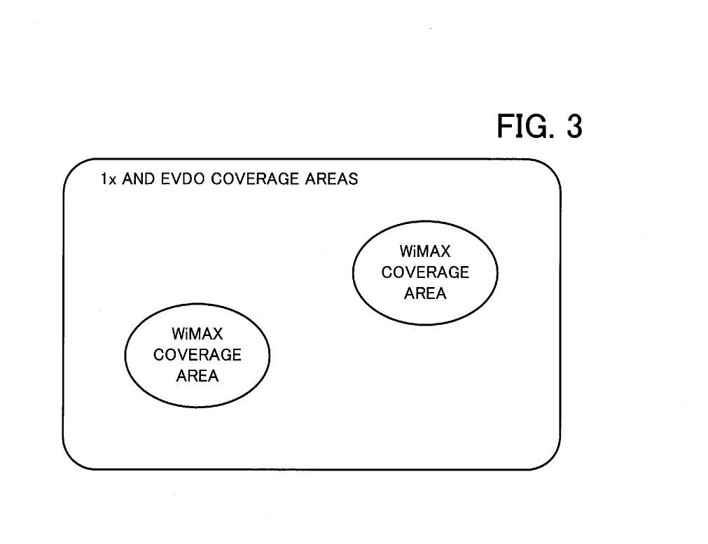

FIG. 3 is an example of a coverage area of a radio access network. In the second embodiment the coverage area of the radio access network 230 (WiMAX) is smaller than the coverage areas of the radio access network 210 (1x) and the radio access network 220 (EVDO) and overlaps with them, to say the least of it. For example, the coverage areas of the radio access networks 210 and 220 are dotted with the coverage area of the radio access network 230.

The coverage area of the radio access network 230 is comparatively small, so there is a possibility that the mobile station 100 moves out of the coverage area of the radio access network 230. However, the mobile station 100 can perform high-speed broadband data communication by the use of the radio access network 230 compared with a case where the mobile station 100 uses the radio access network 220. Accordingly, it is desirable that the mobile station 100 should preferentially use the radio access network 230 at the time of performing data communication in the coverage area of the radio access network 230.

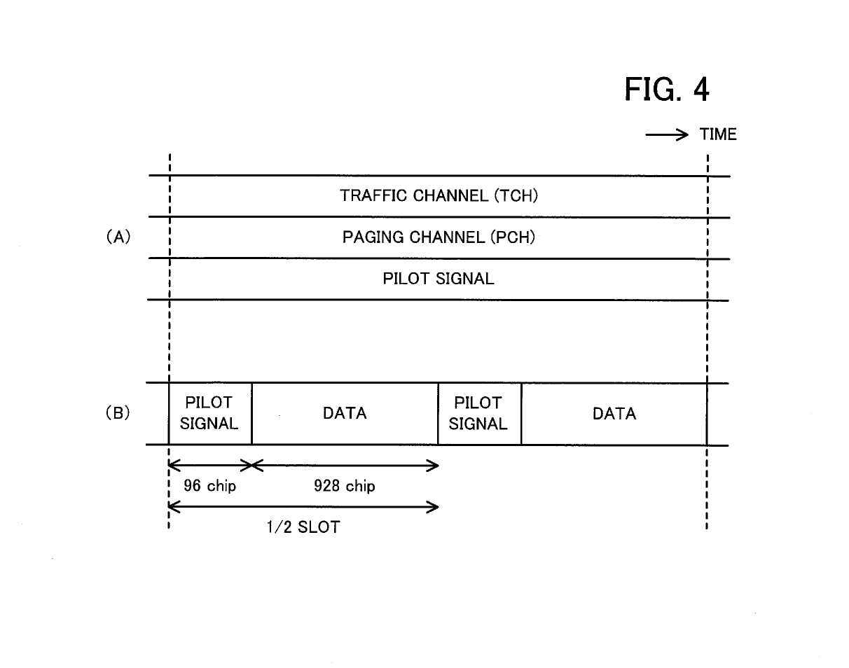

FIG. 4 is an example of a physical channel in a radio access network. FIG. 4(A) is an example of a 1x radio channel transmitted by the radio access network 210 and FIG. 4(B) is an example of an EVDO radio channel transmitted by the radio access network 220.

With the radio access network 210 the base station 211 transmits a TCH (Traffic Channel), a PCH (Paging Channel), and a known pilot signal at different frequencies. The traffic channel may include an audio signal and the paging channel may include paging information indicative of audio receiving. While the mobile station 100 is waiting, the mobile station 100 intermittently checks whether or not there is paging information a destination of which is the mobile station 100, and determines whether or not audio is received. In addition, the mobile station 100 receives the pilot signal and establishes timing synchronization.

With the radio access network 220 the base station 211 transmits data and a known pilot signal at the same frequency on a time-division basis. 928 chips of half a slot (1024 chips) are assigned to data and 96 chips are assigned to a pilot signal. The data may include paging information indicative of data receiving. While the mobile station 100 is waiting, the mobile station 100 intermittently checks whether or not there is paging information a destination of which is the mobile station 100, and determines whether or not data is received. In addition, the mobile station 100 receives the pilot signal and establishes timing synchronization.

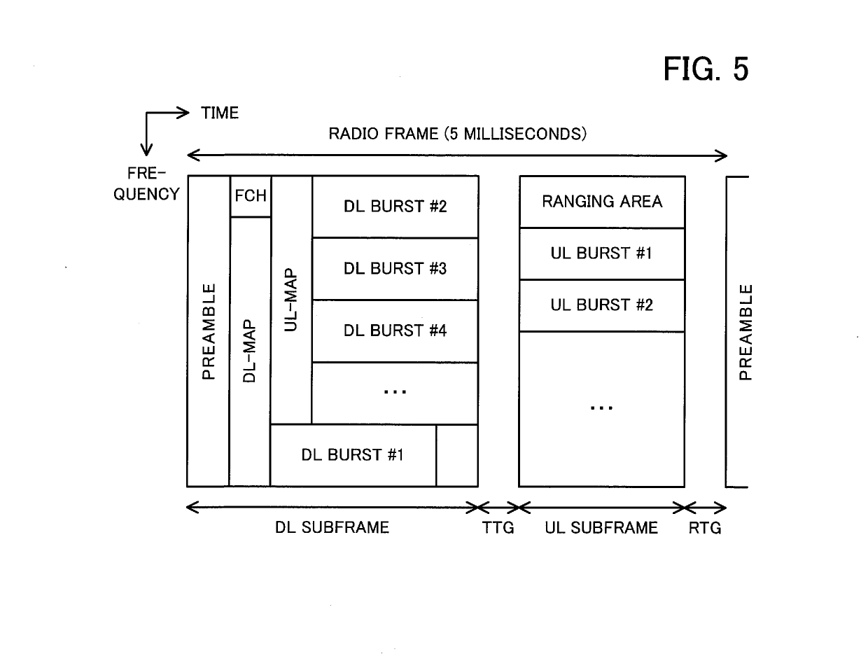

FIG. 5 is an example of a physical channel in another radio access network. FIG. 5 is an example of a WiMAX radio frame transmitted by the radio access network 230.

With OFDMA a radio resource is divided in frequency and time directions and is assigned to various radio channels. A 5-millisecond radio frame includes a DL (DownLink) subframe and a UL (UpLink) subframe. An interval referred to as a TTG (Transmit Transition Gap) is inserted between the DL subframe and the UL subframe. An interval referred to as an RTG (Receive Transition Gap) is inserted between the UL subframe and a DL subframe of the next radio frame.

The DL subframe transmitted by the base station 231 includes a preamble, an FCH (Frame Control Header), DL-MAP, UL-MAP, and DL bursts. The UL subframe transmitted by the mobile station 100 includes a ranging area and UL bursts.

The preamble is a known pilot signal. The FCH includes information used by the mobile station 100 for recognizing a MAP area. The DL-MAP is control information which indicates conditions under which the DL bursts are assigned. The UL-MAP is treated as a part of the DL bursts. The UL-MAP is control information which indicates conditions under which the UL bursts are assigned. The ranging area is treated as a part of the UL bursts. The DL bursts may include data in the packet format, paging information, a UCD (Uplink Channel Descriptor), or the like. The UCD indicates the characteristics of, for example, a modulation and coding scheme which can be used in the UL bursts.

The mobile station 100 can transmit a ranging code which is a determined signal sequence to the base station 231 by the use of the ranging area. By detecting the ranging code, the base station 231 recognizes that there is a mobile station which accesses the base station 231. The mobile station 100 can transmit data in the packet format to the base station 231 by the use of a UL burst. When the mobile station 100 makes a connection to the radio access network 230, the mobile station 100 establishes timing synchronization by receiving a preamble, and transmits a ranging code to the base station 231 by the use of the ranging area. In addition, while the mobile station 100 is waiting, the mobile station 100 intermittently checks whether or not there is paging information a destination of which is the mobile station 100, and determines whether or not data is received.

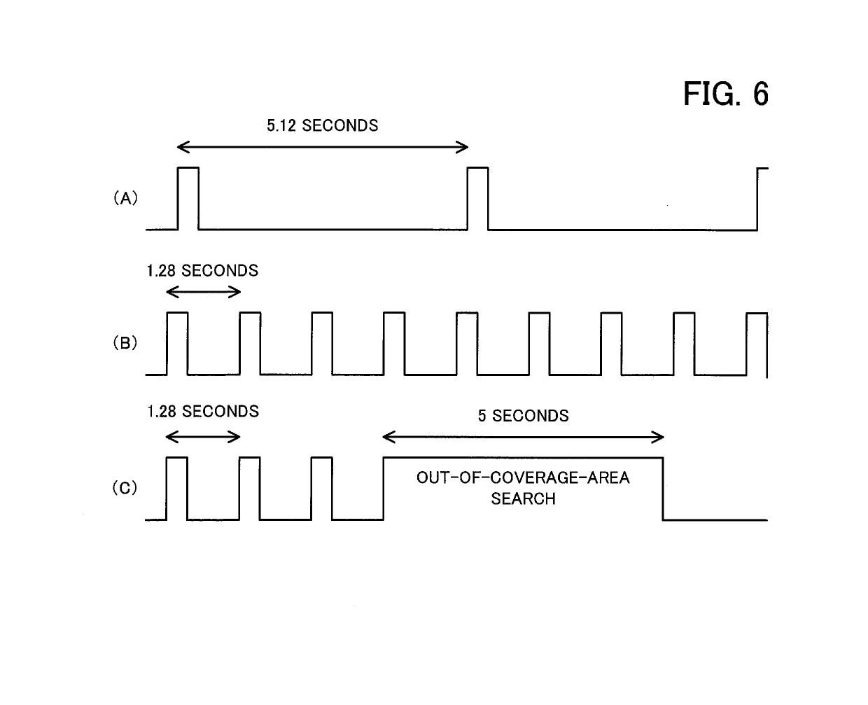

FIG. 6 is an example of timing at which a paging channel is received. The mobile station 100 establishes a PPP connection to the radio access network 220. While the mobile station 100 is waiting in EVDO idle mode, the mobile station 100 intermittently receives a paging channel from the base station 211. Furthermore, the mobile station 100 makes a connection to the radio access network 230. While the mobile station 100 is waiting in WiMAX idle mode, the mobile station 100 intermittently receives a paging channel from the base station 231.

While the mobile station 100 is waiting in, for example, the EVDO idle mode, the mobile station 100 receives a paging channel from the base station 211 every 5.12 seconds (A). At this time a data channel is set in the radio access network 220 and paging information a destination of which is the mobile station 100 is not transmitted from the radio access network 230. Accordingly, there is no need for the mobile station 100 to receive a WiMAX paging channel from the base station 231.

Furthermore, while the mobile station 100 is waiting in, for example, the WiMAX idle mode, the mobile station 100 receives a paging channel from the base station 231 every 1.28 seconds (B). At this time a data channel is set in the radio access network 230 and paging information a destination of which is the mobile station 100 is not transmitted from the radio access network 220. Accordingly, there is no need for the mobile station 100 to receive an EVDO paging channel from the base station 211.

While the mobile station 100 is waiting, the mobile station 100 may fail in receiving a WiMAX paging channel. At this time the mobile station 100 makes a search for a new accessible base station (out-of-coverage-area search) for a maximum of, for example, 5 seconds. If the mobile station 100 cannot detect a new base station in 5 seconds, then the mobile station 100 determines that it has moved out of the coverage area of the radio access network 230. After that, the mobile station 100 may intermittently make an out-of-coverage-area search in order to detect that it has moved again into the coverage area of the radio access network 230.

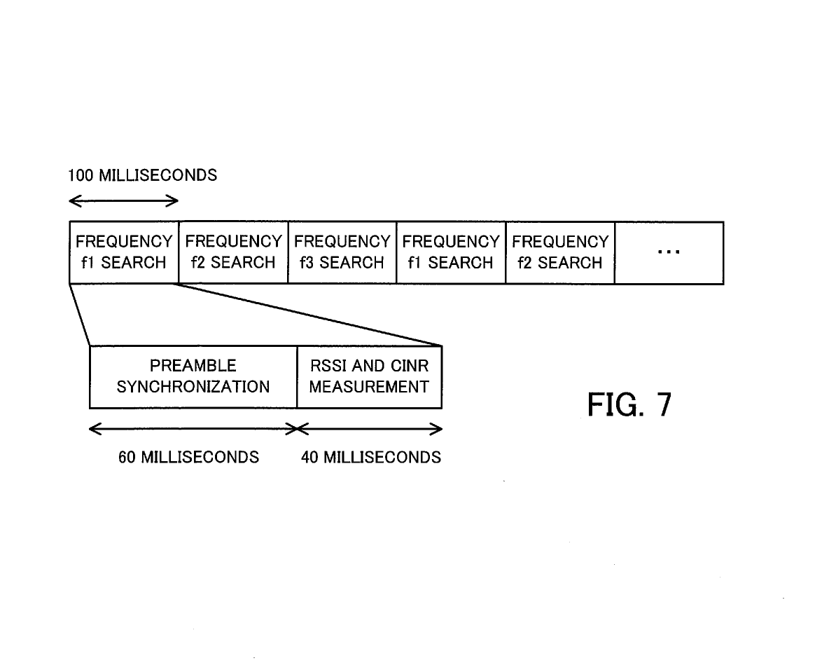

FIG. 7 is an example of an out-of-coverage-area search. In the example of FIG. 7, it is assumed that one of three frequency bands (center frequencies of which are f1=2.62 GHz, f2=2.61 GHz, and f3=2.60 GHz, for example) is used in a cell in the radio access network 230 for performing radio communication. With an out-of-coverage-area search the mobile station 100 switches every 100 milliseconds the frequencies to be searched for, and makes a search for the three frequencies f1, f2, and f3 repeatedly. One 100-millisecond search includes a 60-millisecond first-half process and a 40-millisecond second-half process.

In the 60-millisecond first-half process the mobile station 100 detects a preamble and attempts establishing timing synchronization. The mobile station 100 narrows down 114 candidate preamble indexes to ten. In the 40-millisecond second-half process the mobile station 100 measures RSSI (Received Signal Strength Indication) as a received signal level and measures CINR (Carrier to Interference and Noise Ratio) as receiving quality. In addition, the mobile station 100 specifies used preamble indexes. For example, the mobile station 100 determines that a cell for which RSSI and CINR are greater than or equal to thresholds is accessible to the mobile station 100.

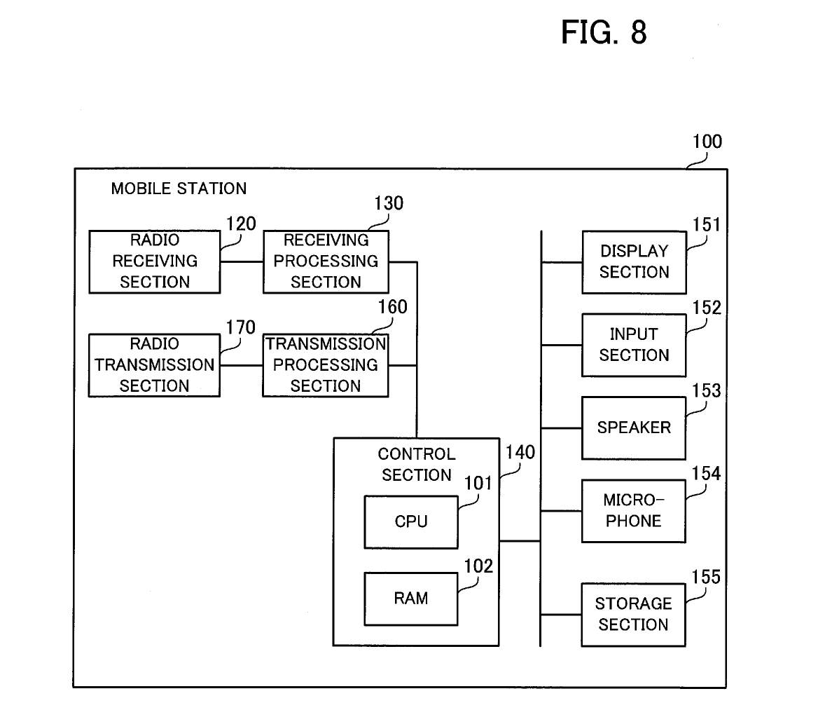

FIG. 8 is a block diagram of an example of the hardware of the mobile station. The mobile station 100 includes a radio receiving section 120, a receiving processing section 130, a control section 140, a display section 151, an input section 152, a speaker 153, a microphone 154, a storage section 155, a transmission processing section 160, and a radio transmission section 170. The control section 140 includes a CPU 101 and a RAM 102.

The radio receiving section 120 processes a radio signal received from the radio access network 210, 220, or 230. The radio receiving section 120 converts (down-converts) a high-frequency radio signal to a digital base band signal and outputs the digital base band signal to the receiving processing section 130.

The receiving processing section 130 acquires the digital base band signal from the radio receiving section 120 as a received signal and performs a base band process including digital demodulation and error correction decoding. The receiving processing section 130 extracts an audio signal or data from the received signal and outputs it to the control section 140.

The control section 140 controls radio communication performed by the use of the radio receiving section 120, the receiving processing section 130, the transmission processing section 160, and the radio transmission section 170. In addition, the control section 140 controls a user interface realized by the use of the display section 151, the input section 152, the speaker 153, and the microphone 154. The control section 140 includes the CPU 101 and the RAM 102.

The CPU 101 is a processor which executes programs such as application programs and driver programs. Driver programs include radio communication programs for controlling the receiving processing section 130 and the transmission processing section 160 and user interface programs for controlling the display section 151 and the input section 152. The CPU 101 reads out at least a part of a program or data stored in the storage section 155, and executes the program. The RAM 102 is a volatile memory which temporarily stores a program or data used by the CPU 101.

If an event does not occur for a certain period of time at the time of the CPU 101 being in the active state, then the CPU 101 shifts to the suspend state in which the power consumption is low. If an event occurs at the time of the CPU 101 being in the suspend state, then the CPU 101 returns to the active state. When the CPU 101 is in the active state, the CPU 101 executes an application program or a driver program. When the CPU 101 is in the suspend state, the CPU 101 terminates an application program or a driver program and waits for an interrupt signal indicative of the occurrence of an event to be inputted. The interrupt signal is inputted via a GPIO signal line.

An event may be the occurrence of data communication such as the generation of transmitted data by the mobile station 100 or the detection, by receiving a paging channel, of paging a destination of which is the mobile station 100. Furthermore, an event may be the movement from the inside to the outside of the coverage area of the radio access network 230 (WiMAX) or the return from the outside to the inside of the coverage area of the radio access network 230 (WiMAX). Moreover, an event may be the detection of a user's operation. For example, when paging a destination of which is the mobile station 100 is detected or the movement from the inside to the outside or from the outside to the inside of the coverage area of the radio access network 230 is detected, an interrupt signal may be inputted from the receiving processing section 130 to the CPU 101. In addition, when the user's operation is detected, an interrupt signal may be inputted from the input section 152 to the CPU 101.

The display section 151 is an interface which acquires a screen frame from the control section 140 and which displays a screen. An LCD (Liquid Crystal Display), an organic EL (ElectroLuminescence) display, or the like can be used as the display section 151.

The input section 152 is an interface which accepts user input and which outputs an input signal to the control section 140. A touch panel, a keypad, or the like can be used as the input section 152. If a touch panel is used, it is placed on the display section 151 for detecting a position on a screen at which the user touches. A pointing device, such as a touch pen, or the user's finger is used for performing touch operation. A touch position can be detected by the use of a detection method such as a matrix switch method, a resistance film method, a surface acoustic wave method, an infrared ray method, an electromagnetic induction method, or an electrostatic capacitance method. If a keypad is used, one or more input keys are arranged on the surface of an enclosure of the mobile station 100.

The speaker 153 is an interface which converts an electrical signal as an audio signal acquired from the control section 140 to physical vibrations for reproducing sound. For example, when the user is speaking by the mobile station 100, voice or background noise at the other end of the mobile station 100 is outputted from the speaker 153.

The microphone 154 is an interface which accepts audio input by converting sound caused by physical vibrations to an electrical signal and which outputs the electrical signal as an audio signal to the control section 140. For example, when the user is speaking by the mobile station 100, the user's voice or background noise is inputted from the microphone 154.

The storage section 155 is a nonvolatile memory which stores programs and data. The storage section 155 may be a flash memory. The programs include application programs and driver programs which correspond to the interfaces included in the mobile station 100.

The transmission processing section 160 acquires an audio signal or data generated by the mobile station 100 from the control section 140, and performs a base band process including digital modulation and error correction coding. The transmission processing section 160 outputs a digital base band signal as a transmitted signal to the radio transmission section 170.

The radio transmission section 170 processes a transmitted signal to be transmitted to the radio access network 210, 220, or 230. The radio transmission section 170 converts (up-converts) the digital base band signal acquired from the transmission processing section 160 to a high-frequency radio signal and outputs it from an antenna.

For example, the receiving processing section 130 and the transmission processing section 160 are connected to the control section 140 via SDIO (Secure Digital Input/Output) signal lines for transmitting data signals and GPIO signal lines. Furthermore, for example, the display section 151, the input section 152, the speaker 153, the microphone 154, and the storage section 155 are connected to the control section 140 via a bus.

The radio receiving section 120 and the receiving processing section 130 are an example of the receiving section 11 in the first embodiment. The control section 140 is an example of the control section 12 in the first embodiment. The CPU 101 is an example of the processor 12a in the first embodiment.

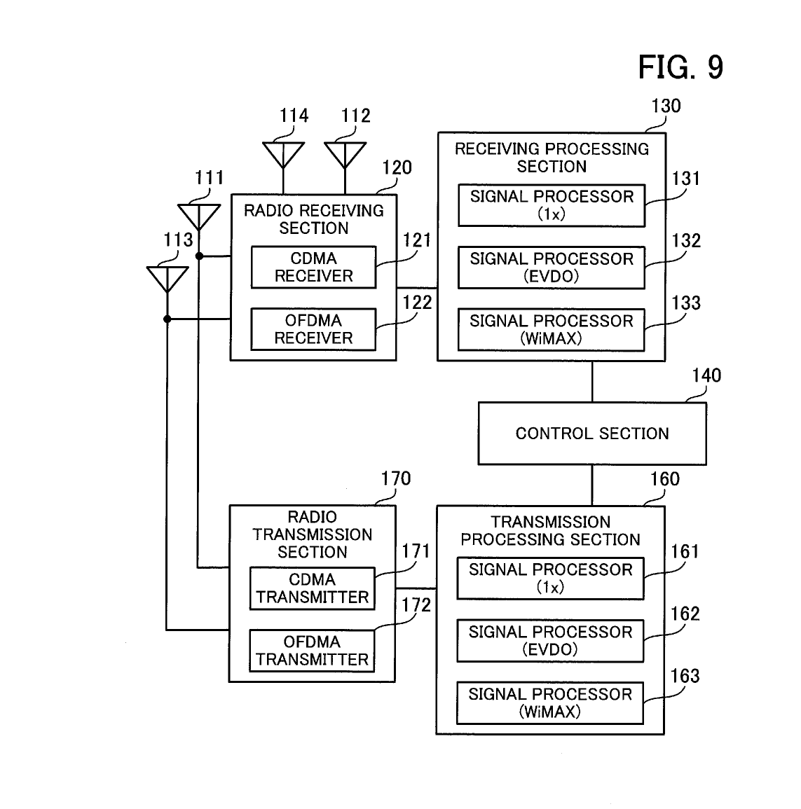

FIG. 9 is a block diagram on radio transmission and receiving. In addition to the components illustrated in FIG. 8, the mobile station 100 includes antennas 111, 112, 113, and 114.

The antennas 111 and 113 are used both for transmission and for receiving. The antennas 112 and 114 are used for receiving. The antennas 111 and 112 receive radio signals from the radio access networks 210 and 220. In addition, the antenna 111 transmits radio signals to the radio access networks 210 and 220. The antennas 113 and 114 receive radio signals from the radio access network 230. In addition, the antenna 113 transmits radio signals to the radio access network 230.

The radio receiving section 120 includes a CDMA receiver 121 and an OFDMA receiver 122. The CDMA receiver 121 processes 1x and EVDO radio signals received by the antennas 111 and 112. Diversity communication or MIMO (Multiple Input Multiple Output) communication may be performed by the use of the antennas 111 and 112. The OFDMA receiver 122 processes WiMAX radio signals received by the antennas 113 and 114. Diversity communication or MIMO communication may be performed by the use of the antennas 113 and 114.

The receiving processing section 130 includes signal processors 131, 132, and 133. The signal processor 131 acquires a digital base band signal from the CDMA receiver 121, performs a 1x base band process, and extracts an audio signal. The signal processor 132 acquires a digital base band signal from the CDMA receiver 121, performs an EVDO base band process, and extracts data in the packet format. The base band process performed by the signal processor 131 or 132 includes inverse diffusion demodulation. The signal processor 133 acquires a digital base band signal from the OFDMA receiver 122, performs a WiMAX base band process, and extracts data in the packet format. The base band process performed by the signal processor 133 includes an FFT (Fast Fourier Transform).

The transmission processing section 160 includes signal processors 161, 162, and 163. The signal processor 161 acquires an audio signal from the control section 140 and performs a 1x base band process. The signal processor 162 acquires data from the control section 140 and performs an EVDO base band process. The base band process performed by the signal processor 161 or 162 includes diffusion modulation. The signal processor 163 acquires data from the control section 140 and performs a WiMAX base band process. The base band process performed by the signal processor 163 includes an IFFT (Inverse Fast Fourier Transform).

The radio transmission section 170 includes a CDMA transmitter 171 and an OFDMA transmitter 172. The CDMA transmitter 171 processes a 1x digital base band signal acquired from the signal processor 161 or an EVDO digital base band signal acquired from the signal processor 162, and outputs a radio signal to the antenna 111 as a transmitted signal. The OFDMA transmitter 172 processes a WiMAX digital base band signal acquired from the signal processor 163, and outputs a radio signal to the antenna 113 as a transmitted signal.

While the mobile station 100 is not performing audio communication or data communication, that is to say, the mobile station 100 is waiting, the signal processor 131 intermittently operates, registers the position of the mobile station 100 in the radio access network 210 (1x), and receives a paging channel. While the mobile station 100 is waiting, the signal processor 132 intermittently operates and registers the position of the mobile station 100 in the radio access network 220 (EVDO). In addition, when a PPP connection is valid, the signal processor 132 receives a paging channel. When a PPP connection is invalid, there is no need for the signal processor 132 to receive a paging channel. While the mobile station 100 is waiting, the signal processor 133 intermittently operates and registers the position of the mobile station 100 in the radio access network 230 (WiMAX). In addition, when a connection to the radio access network 230 is valid, the signal processor 133 receives a paging channel. When a connection to the radio access network 230 is invalid, there is no need for the signal processor 133 to receive a paging channel. Furthermore, the signal processor 131, 132, or 133 makes a base station search according to circumstances.

While the mobile station 100 is waiting, the signal processor 131, 132, or 133 can stop signal processing. However, the signal processor 131, 132, or 133 cannot stop signal processing at timing at which it should perform the above processes (timing at which it should receive a paging channel, for example). For example, before the mobile station 100 goes into a wait state, the base station 211 or 231 informs the mobile station 100 about timing at which the signal processor 131, 132, or 133 should receive a paging channel. While the CPU 101 is in the suspend state, the signal processor 131, 132, or 133 intermittently performs signal processing in accordance with instructions from the control section 140 which are issued before the CPU 101 goes into the suspend state.

While the CPU 101 is in the suspend state, the mobile station 100 may detect paging information a destination of which is the mobile station 100. When the mobile station 100 is outside the coverage area, the mobile station 100 may detect a new base station. At such times the signal processor 131, 132, or 133 transmits an interrupt signal to the CPU 101. Furthermore, while the CPU 101 is in the suspend state, the mobile station 100 may detect the movement from the inside to the outside of the coverage area of the radio access network 230 (WiMAX). At this time the signal processor 133 transmits an interrupt signal to the CPU 101. Stopping signal processing includes stopping the supply of power to a corresponding circuit or decreasing a clock frequency for a corresponding circuit. While the mobile station 100 is waiting, the transmission processing section 160 and the radio transmission section 170 may also operate intermittently.

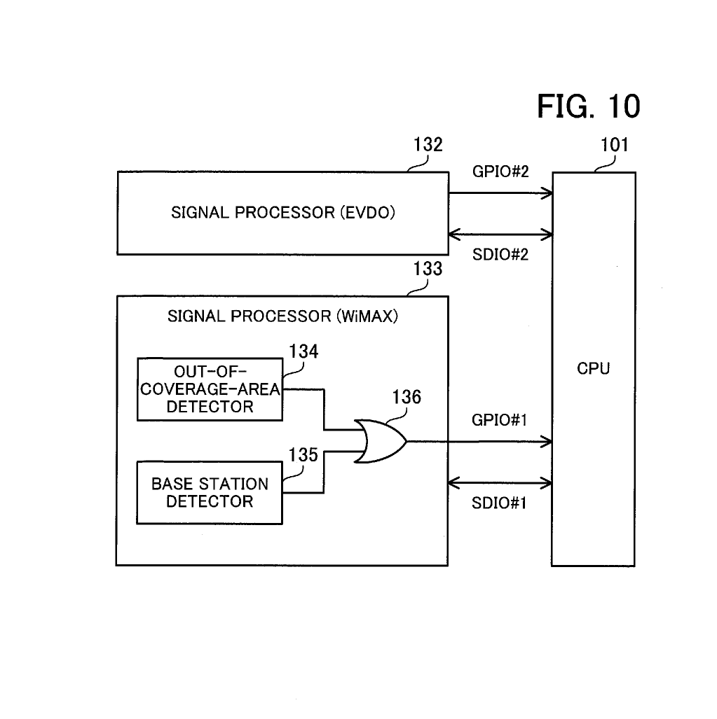

FIG. 10 is a block diagram on a CPU interrupt. The signal processor 133 is connected to the CPU 101 via a GPIO signal line (GPIO #1) and an SDIO signal line (SDIO #1). The signal processor 132 is connected to the CPU 101 via a GPIO signal line (GPIO #2) and an SDIO signal line (SDIO #2). GPIO #1 and GPIO #2 are used for transmitting interrupt signals. SDIO #1 and SDIO #2 are used for transmitting data signals. In FIG. 10, the signal processor 131 is omitted.

The signal processor 133 includes an out-of-coverage-area detector 134, a base station detector 135, and an OR circuit 136. While the CPU 101 is in the suspend state, the out-of-coverage-area detector 134 may detect the movement to the outside of the coverage area from conditions under which radio signals are received from the radio access network 230. At this time the out-of-coverage-area detector 134 outputs an interrupt signal. For example, when a base station for which a receiving power level is higher than or equal to a threshold is not detected by a base station search, the out-of-coverage-area detector 134 determines that the mobile station 100 has moved out of the coverage area of the radio access network 230. While the CPU 101 is in the suspend state, the base station detector 135 may detect the return from the outside to the inside of the coverage area from conditions under which radio signals are received from the radio access network 230. At this time the base station detector 135 outputs an interrupt signal. The OR circuit 136 calculates the logical sum of the interrupt signals. When one of the out-of-coverage-area detector 134 and the base station detector 135 outputs an interrupt signal, the OR circuit 136 outputs an interrupt signal to the CPU 101.

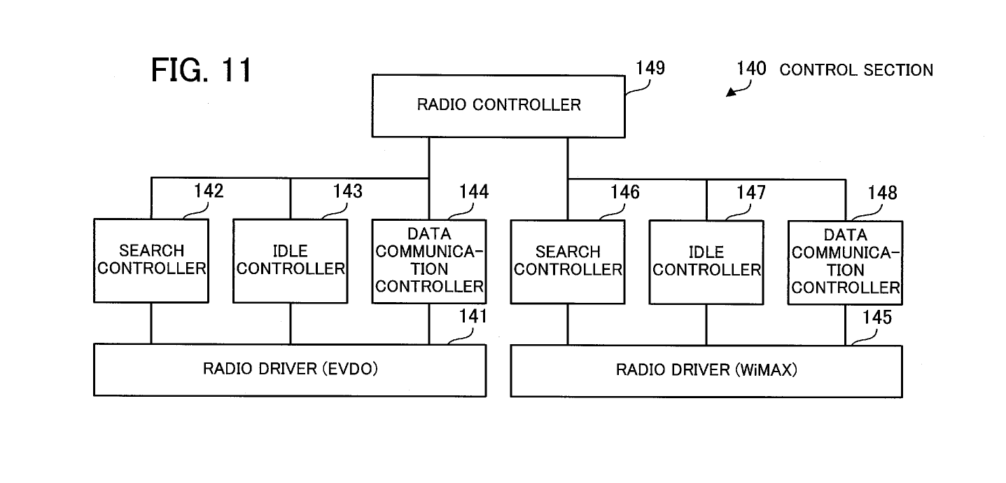

FIG. 11 is a block diagram of an example of software executed by the control section. The control section 140 includes radio drivers 141 and 145, search controllers 142 and 146, idle controllers 143 and 147, data communication controllers 144 and 148, and a radio controller 149.

Each block illustrated in FIG. 11 can be realized as a module included in a program executed by the CPU 101. When the CPU 101 is in the suspend state, a process corresponding to each block illustrated in FIG. 11 is stopped. When an interrupt signal is inputted to the CPU 101, the radio controller 149 resumes a process and invokes other blocks. FIG. 11 illustrates blocks on control of data communication performed by the use of the radio access networks 220 and 230. Blocks on control of audio communication performed by the use of the radio access network 210 are omitted.

The radio driver 141 controls signal processing by the signal processor 132 or 162 regarding EVDO data communication. The radio driver 145 controls signal processing by the signal processors 133 and 163 regarding WiMAX data communication.

The search controller 142 gives the signal processor 132 instructions via the radio driver 141 to make a search for a base station in the radio access network 220. The search controller 146 gives the signal processor 133 instructions via the radio driver 145 to make a search for a base station in the radio access network 230.

The idle controller 143 detects the beginning and end of EVDO data communication and gives the signal processor 132 or 162 instructions via the radio driver 141 to perform switching between EVDO active mode and idle mode. The idle controller 147 detects the beginning and end of WiMAX data communication and gives the signal processor 133 or 163 instructions via the radio driver 145 to perform switching between WiMAX active mode and idle mode.

The data communication controller 144 controls EVDO data communication. The data communication controller 148 controls WiMAX data communication.

The radio controller 149 supervises control of a PPP connection to the radio access network 220, a connection to the radio access network 230, hand-over between the radio access networks 220 and 230, and the like.

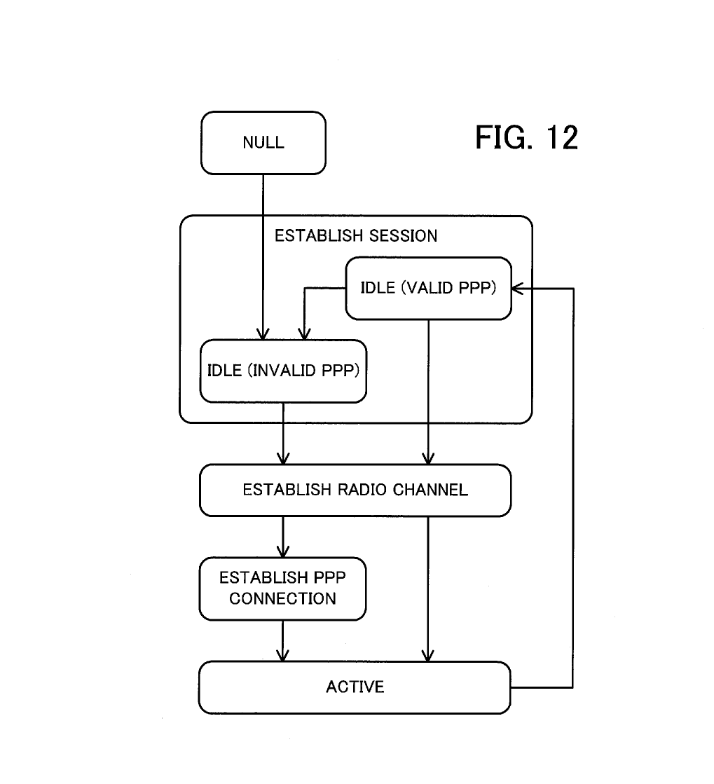

FIG. 12 is an example of the transition of a data communication state. FIG. 12 indicates a state in which data communication is performed between the radio access network 220 and the mobile station 100.

The state “NULL” is a state in which the mobile station 100 stops signal processing regarding the radio access network 220, and corresponds to a state in which power to the mobile station 100 is off. When the power to the mobile station 100 is turned on, the mobile station 100 transmits a message to or receives a message from the base station 211 in a radio interval. As a result, the transition from the state “NULL” to the state “idle (invalid PPP)” takes place.

The state “idle (invalid PPP)” is a state in which the mobile station 100 does not establish a PPP connection to the radio access network 220. To perform data communication, the mobile station 100 establishes a TCH (Traffic Channel), which is a radio channel, with the base station 211. By doing so, the transition from the state “idle (invalid PPP)” to the state “radio channel established” takes place. When the mobile station 100 establishes a PPP connection to the PDSN 222 via the base station 211, the transition from the state “radio channel established” to the state “PPP connection established” takes place.

The state “PPP connection established” is a state in which the mobile station 100 establishes a PPP connection to the radio access network 220. When the mobile station 100 begins data communication in the packet format via the PPP connection, the transition from the state “PPP connection established” to the state “active” takes place. The state “active” is a state in which the mobile station 100 is performing data communication by the use of the radio access network 220. When data communication by the mobile station 100 ends, the transition from the state “active” to the state “idle (valid PPP)” takes place.

The state “idle (valid PPP)” is a state in which a PPP connection is maintained. When the mobile station 100 performs data communication as a result of the generation of transmitted data or paging, the mobile station 100 establishes a traffic channel again. By doing so, the transition from the state “idle (valid PPP)” to the state “radio channel established” takes place. However, the PPP connection is already valid, so the mobile station 100 begins data communication via the PPP connection. By doing so, the transition from the state “radio channel established” to the state “active” takes place. On the other hand, when the mobile station 100 makes a connection to the radio access network 230, the PPP connection to the radio access network 220 becomes invalid and the transition from the state “idle (valid PPP)” to the state “idle (invalid PPP)” takes place.

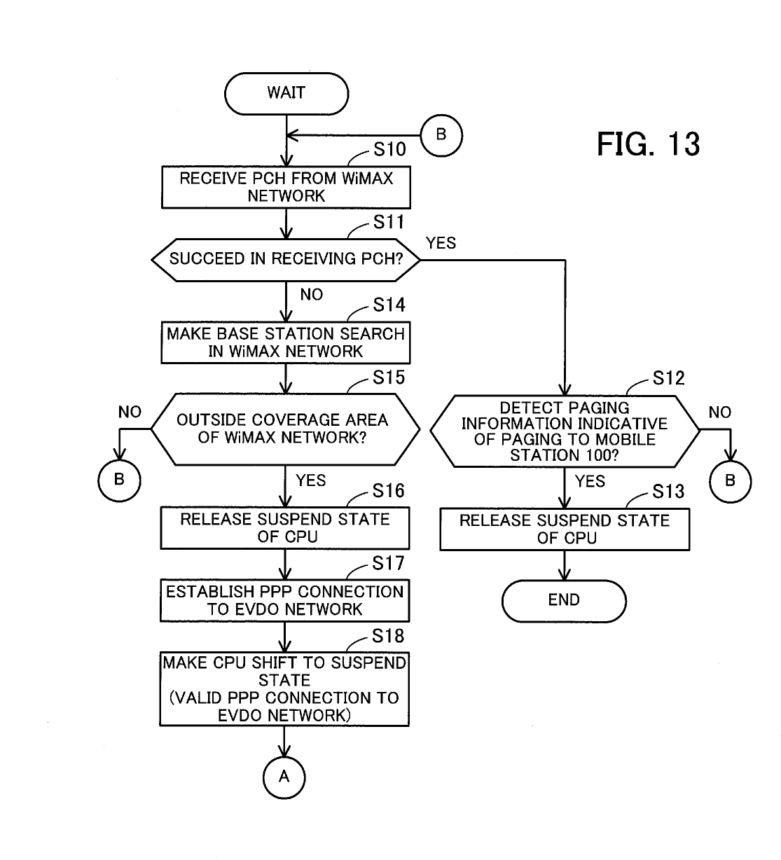

FIG. 13 is a flow chart of an example of wait by the mobile station (part 1). It is assumed that a data channel is set in the radio access network 230 (WiMAX), that the mobile station 100 is waiting in a WiMAX idle state, and that the CPU 101 is in the suspend state. When the mobile station 100 goes into the wait state after performing data communication by the use of the radio access network 230, the data channel remains set in the radio access network 230.

(Step S10) When timing designated at the time of the mobile station 100 shifting to the wait state comes, the signal processor 133 starts and attempts receiving a paging channel from the radio access network 230.

(Step S11) The signal processor 133 determines whether or not it succeeds in receiving a paging channel in step S10. If the signal processor 133 succeeds in receiving a paging channel in step S10, then the signal processor 133 proceeds to step S12. If the signal processor 133 cannot detect a paging channel and fails in receiving a paging channel, then the signal processor 133 proceeds to step S14.

(Step S12) The signal processor 133 determines whether or not paging information indicative of paging a destination of which is the mobile station 100 is included in the paging channel. If the signal processor 133 detects paging information indicative of paging a destination of which is the mobile station 100, then the signal processor 133 proceeds to step S13. If the signal processor 133 does not detect paging information indicative of paging a destination of which is the mobile station 100, then the signal processor 133 stops signal processing, waits for the next receiving timing to come, and proceeds to step S10.

(Step S13) In order to begin data receiving, the signal processor 133 transmits an interrupt signal to the CPU 101 via GPIO #1. As a result, the suspend state of the CPU 101 is released and the CPU 101 returns to the active state. The process then terminates.

(Step S14) The signal processor 133 begins to make a search for a base station in the radio access network 230. For example, the signal processor 133 attempts receiving a preamble of a radio frame at the above three frequencies for a maximum of 5 seconds.

(Step S15) The signal processor 133 determines whether or not it detects a base station by making the base station search in step S14. If the signal processor 133 detects a base station, then the signal processor 133 determines that the mobile station 100 is in the coverage area of the radio access network 230, stops signal processing, and proceeds to step S10. If a base station is not detected and a time-out occurs, then the signal processor 133 determines that the mobile station 100 is outside the coverage area of the radio access network 230, and proceeds to step S16.

(Step S16) The signal processor 133 transmits an interrupt signal to the CPU 101 via GPIO #1. As a result, the suspend state of the CPU 101 is released and the CPU 101 returns from the suspend state to the active state.

(Step S17) The control section 140 controls the signal processor 132 or 162 by the use of the CPU 101 the suspend state of which is released, and establishes a PPP connection to the PDSN 222. As a result, a data channel is set in the radio access network 220 (EVDO) and the connection to the radio access network 230 becomes invalid. If there is paging regarding data communication a destination of which is the mobile station 100, the signal processor 132 can receive paging information from the radio access network 220. In order to detect that the mobile station 100 returns to the coverage area of the radio access network 230, the control section 140 makes the signal processor 133 continue to intermittently make a base station search.

(Step S18) The control section 140 makes the CPU 101 shift to the suspend state. At this time the mobile station 100 has gone into the state “idle (valid PPP)” for the radio access network 220. The mobile station 100 waits in an EVDO idle state.

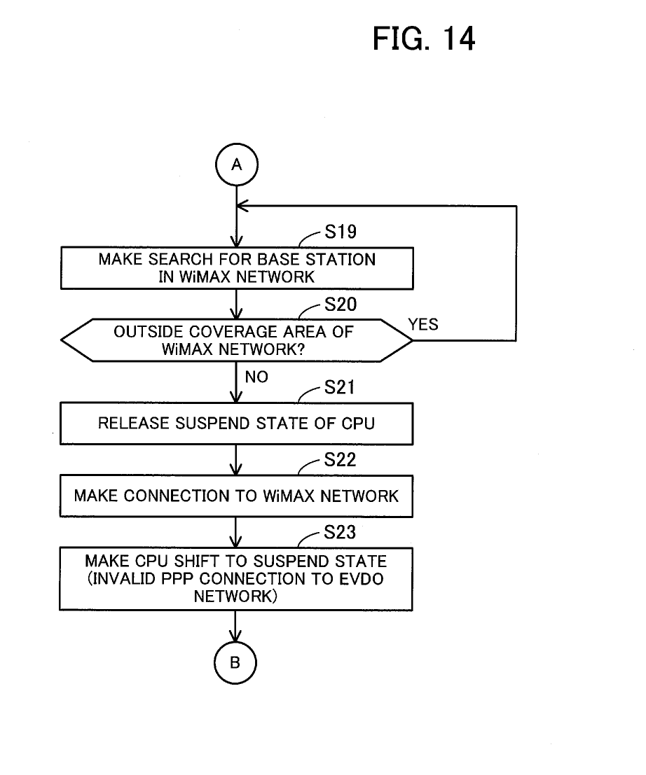

FIG. 14 is a flow chart of an example of wait by the mobile station (part 2).

(Step S19) When timing designated by the control section 140 before the shift of the CPU 101 to the suspend state comes, the signal processor 133 starts and makes a search for a base station in the radio access network 230. For example, the signal processor 133 attempts receiving a preamble of a radio frame at the above three frequencies for a maximum of 5 seconds.

(Step S20) The signal processor 133 determines whether or not it detects a base station by making the base station search in step S19. If the signal processor 133 does not detect a base station, then the signal processor 133 determines that the mobile station 100 is outside the coverage area of the radio access network 230, stops signal processing, waits for the next search timing to come, and proceeds to step S19. If the signal processor 133 detects a base station, then the signal processor 133 determines that the mobile station 100 has returned to the coverage area of the radio access network 230, and proceeds to step S21.

(Step S21) The signal processor 133 transmits an interrupt signal to the CPU 101 via GPIO #1. As a result, the suspend state of the CPU 101 is released and the CPU 101 returns from the suspend state to the active state.

(Step S22) The control section 140 controls the signal processor 133 or 163 by the use of the CPU 101 the suspend state of which is released, and makes a connection to the radio access network 230. As a result, a data channel is set in the radio access network 230 and the PPP connection to the radio access network 220 becomes invalid. If there is paging regarding data communication a destination of which is the mobile station 100, the signal processor 133 can receive paging information from the radio access network 230.

(Step S23) The control section 140 makes the CPU 101 shift to the suspend state. At this time the mobile station 100 has gone into the state “idle (invalid PPP)” for the radio access network 220. Step S10 is then performed.

In the flow indicated in FIG. 14, description of the process of receiving a paging channel from the radio access network 220 is omitted. In parallel with steps S19 and S20, the signal processor 132 intermittently starts and receives a paging channel from the radio access network 220. When the signal processor 132 detects from a paging channel paging information a destination of which is the mobile station 100, the signal processor 132 transmits an interrupt signal to the CPU 101 and releases its suspend state. By doing so, data communication is begun.

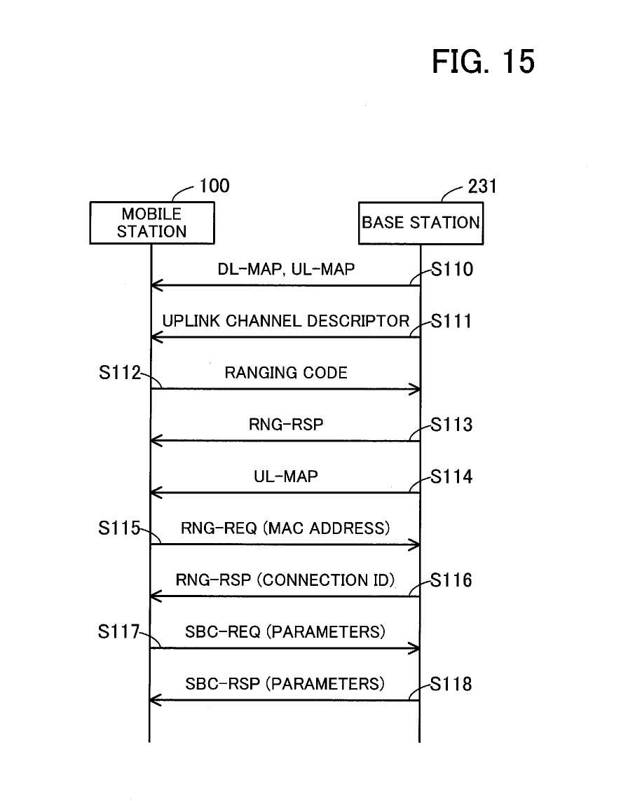

FIG. 15 is a sequence diagram of an example of making a connection to a radio access network (part 1). In FIG. 15, an example of a procedure under which the mobile station 100 makes a connection to the radio access network 230 is indicated. The sequence indicated in FIG. 15 is performed in, for example, the above step S22.

The base station 231 transmits by a DL-subframe DL-MAP and UL-MAP which indicate assignment of radio resources. The mobile station 100 receives the DL-MAP from the base station 231, confirms the position of the UL-MAP, and receives the UL-MAP (step S110). The base station 231 transmits a UCD (Uplink Channel Descriptor) indicative of the physical characteristics (such as a usable modulation and coding scheme) of a UL subframe by a DL burst in the DL subframe. The mobile station 100 refers to the DL-MAP and receives the UCD (step S111).

The mobile station 100 refers to the UL-MAP and the UCD received from the base station 231, and specifies the position of a ranging area set in the UL subframe and a usable ranging code. The mobile station 100 then transmits the ranging code to the base station 231 (step S112). When the base station 231 detects the ranging code, the base station 231 transmits a ranging response (RNG-RSP) message in its cell. At this point of time the base station 231 does not recognize a source of the ranging code (step S113).

The base station 231 assigns a radio resource of a UL burst to the source of the ranging code and transmits UL-MAP in which an assignment result is reflected (step S114). When the mobile station 100 receives the RNG-RSP message from the base station 231, the mobile station 100 refers to the UL-MAP and confirms the radio resource of the UL burst assigned thereto. The mobile station 100 then uses the assigned radio resource for transmitting a ranging request (RNG-REQ) message to the base station 231. The RNG-REQ message includes a MAC (Medium Access Control) address for identifying the mobile station 100 (step S115).

The base station 231 receives the RNG-REQ message, recognizes the mobile station 100, and gives connection ID for identifying a connection. The base station 231 then transmits to the mobile station 100 a ranging response (RNG-RSP) message including the connection ID. After that, the mobile station 100 communicates with the base station 231 by the use of the connection ID (step S116). In order to exchange physical layer information with the base station 231, the mobile station 100 transmits a message (SBC-REQ) including its physical parameters and information regarding its security system (step S117). The base station 231 transmits a message (SBC-RSP) including its physical parameters and information regarding its security system (step S118).

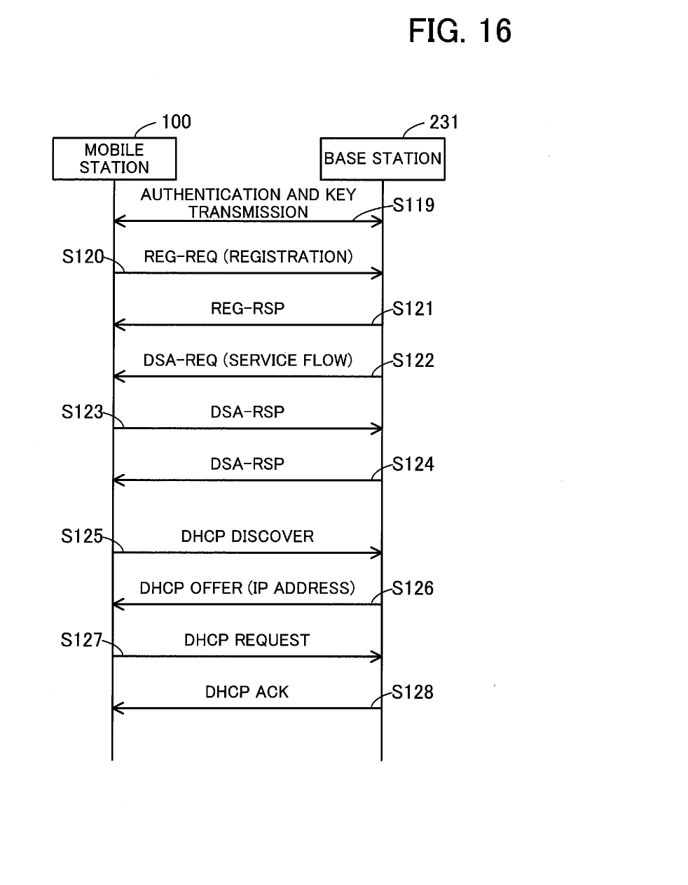

FIG. 16 is a sequence diagram of an example of making a connection to a radio access network (part 2). FIG. 16 is continued from FIG. 15 and indicates an example of a procedure under which the mobile station 100 makes a connection to the radio access network 230. The sequence indicated in FIG. 16 is performed in, for example, the above step S22.

The mobile station 100 and the base station 231 authenticate the mobile station 100 by the use of EAP (Extensible Authentication Protocol) and transmit a cryptographic key used for transmitting data to the mobile station 100 (step S119). The mobile station 100 transmits a registration request (REG-REQ) message including information regarding its communication capability to the base station 231 (step S120). The base station 231 determines a radio communication operation mode on the basis of the communication capability of the mobile station 100 and the base station 231 and transmits a registration response (REG-RSP) message including information regarding the operation mode to the mobile station 100 (step S121).

When the operation mode is determined by negotiations between the mobile station 100 and the base station 231, the base station 231 transmits a dynamic service addition request (DSA-REQ) message to the mobile station 100 in order to set an initial service flow used for assigning an IP address (step S122). The mobile station 100 confirms transaction ID and the contents of a service, such as a QoS (Quality of Service) parameter, and transmits a dynamic service addition response (DSA-RSP) message to the base station 231 (step S123). The base station 231 sets an initial service flow and transmits a DSA-RSP message to the mobile station 100 (step S124).

When the initial service flow is set, the mobile station 100 transmits a DISCOVER message to the base station 231 by the use of DHCP (Dynamic Host Configuration Protocol) (step S125). The base station 231 transmits to the mobile station 100 an OFFER message indicative of a candidate IP address assigned to the mobile station 100 (step S126). The mobile station 100 confirms that the use of the candidate IP address about which the base station 231 informs the mobile station 100 does not cause a problem, and transmits a REQUEST message to the base station 231 (step S127). The base station 231 transmits to the mobile station 100 an ACK message which indicates that the candidate IP address about which the base station 231 previously informs the mobile station 100 is assigned to the mobile station 100 (step S128).

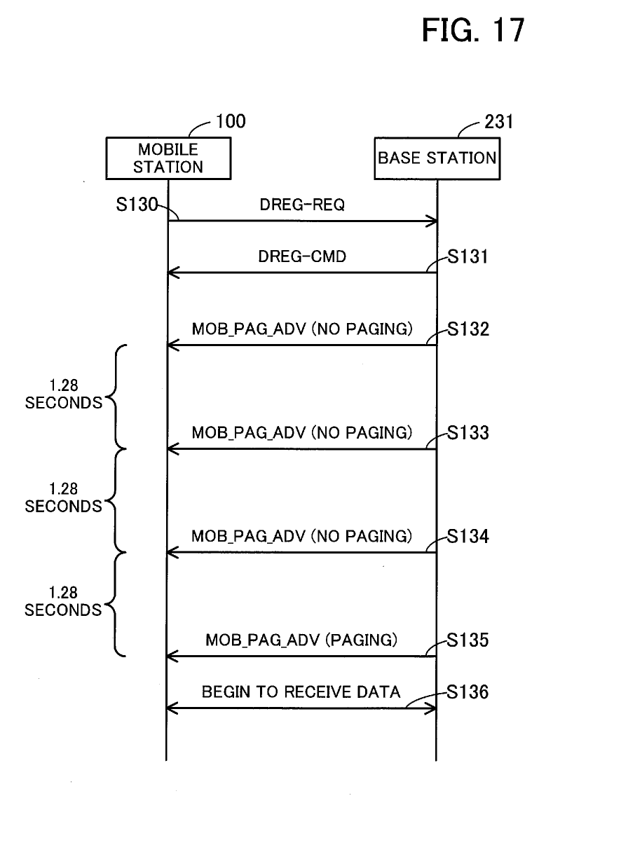

FIG. 17 is a sequence diagram of an example of receiving a paging channel. FIG. 17 indicates a case where a data channel is set in the radio access network 230 (WiMAX) and where the mobile station 100 receives a paging channel from the radio access network 230.

When ten seconds elapse after the termination of data communication performed by the use of the radio access network 230, the mobile station 100 shifts to a WiMAX idle state. Accordingly, the mobile station 100 transmits a deregistration request (DREG-REQ) message to the base station 231. (action code)=1 is designated in the DREG-REQ message (step S130). When the base station 231 allows the mobile station 100 to shift to the WiMAX idle state, the base station 231 transmits a deregistration command (DREG-CMD) message to the mobile station 100. (action code)=5 is designated in the DREG-CMD message (step S131).

The base station 231 periodically transmits a message (MOB_PAG_ADV) by a paging channel. The mobile station 100 receives a paging channel in a determined cycle (1.28-second cycle, for example) and determines whether or not there is paging a destination of which is the mobile station 100. If there is no paging a destination of which is the mobile station 100, then the mobile station 100 stops processing a signal received from the radio access network 230 until timing at which the mobile station 100 receives a paging channel next (steps S132, S133, and S134). When the mobile station 100 detects paging thereto, the mobile station 100 releases the WiMAX idle state (step S135) and begins to receive data from the radio access network 230 (step S136).

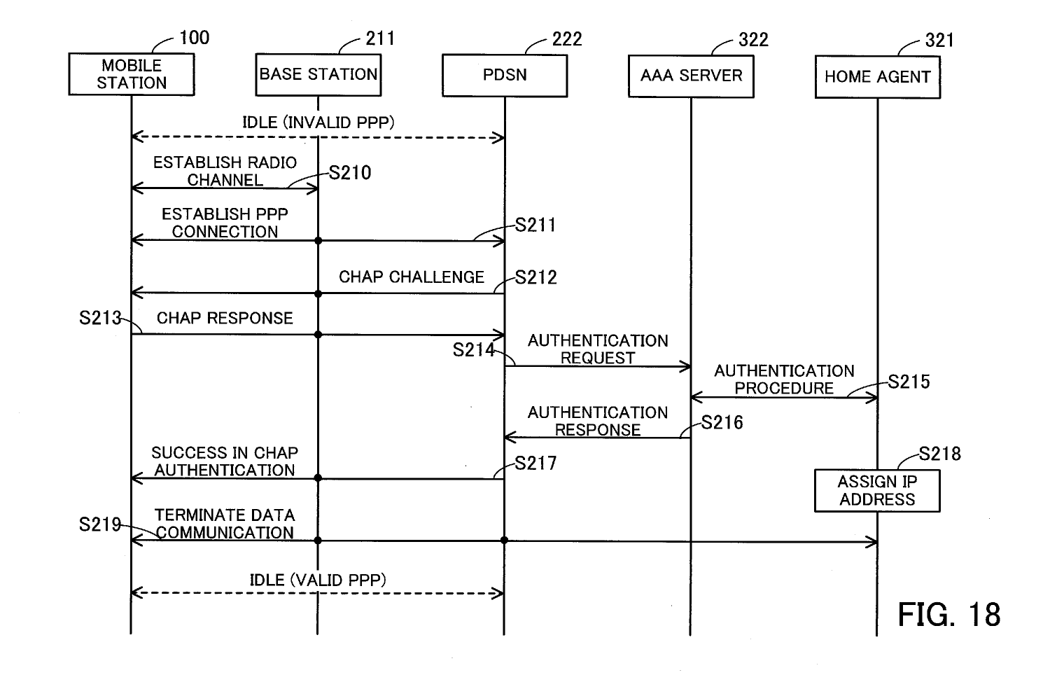

FIG. 18 is a sequence diagram of an example of making a connection to another radio access network. In FIG. 18, an example of a procedure under which the mobile station 100 in the state “idle (invalid PPP)” establishes a PPP connection and under which the mobile station 100 makes a transition to the state “idle (valid PPP)” is indicated. The sequence indicated in FIG. 18 is performed in, for example, the above step S17.

The mobile station 100 communicates with the base station 211 and establishes a traffic channel which is a radio channel (step S210). The mobile station 100 accesses the base station 211 through the traffic channel and establishes a PPP connection between the mobile station 100 and the PDSN 222 via the base station 211 and the PCF 221 (step S211).

In order to authenticate the mobile station 100, the PDSN 222 transmits a CHAP (Challenge Handshake Authentication Protocol) challenge message including a generated random number to the mobile station 100 (step S212). The mobile station 100 applies a determined one-way function (hash function, for example) to the random number and transmits a CHAP response message including a calculation result to the PDSN 222. If the calculation result transmitted from the mobile station 100 matches an “expected calculation result” produced on the network side by applying the generated random number to the determined one-way function, then the mobile station 100 is authorized to have connection authority (step S213).

The PDSN 222 requests the AAA server 322 to authenticate the mobile station 100 (step S214). The AAA server 322 exchanges authentication procedure messages with the home agent 321 and registers the mobile station 100 in the home agent 321 (step S215). The AAA server 322 transmits to the PDSN 222 a response message indicative of success in authentication (step S216). The PDSN 222 transmits to the mobile station 100 a message indicative of success in CHAP authentication (step S217). In addition, the home agent 321 assigns an IP address to the mobile station 100 (step S218).

When the mobile station 100 is authenticated and the IP address is assigned to the mobile station 100, the mobile station 100 terminates data communication (step S219). The mobile station 100 goes into the EVDO idle state and the PPP connection established between the mobile station 100 and the PDSN 222 is maintained.

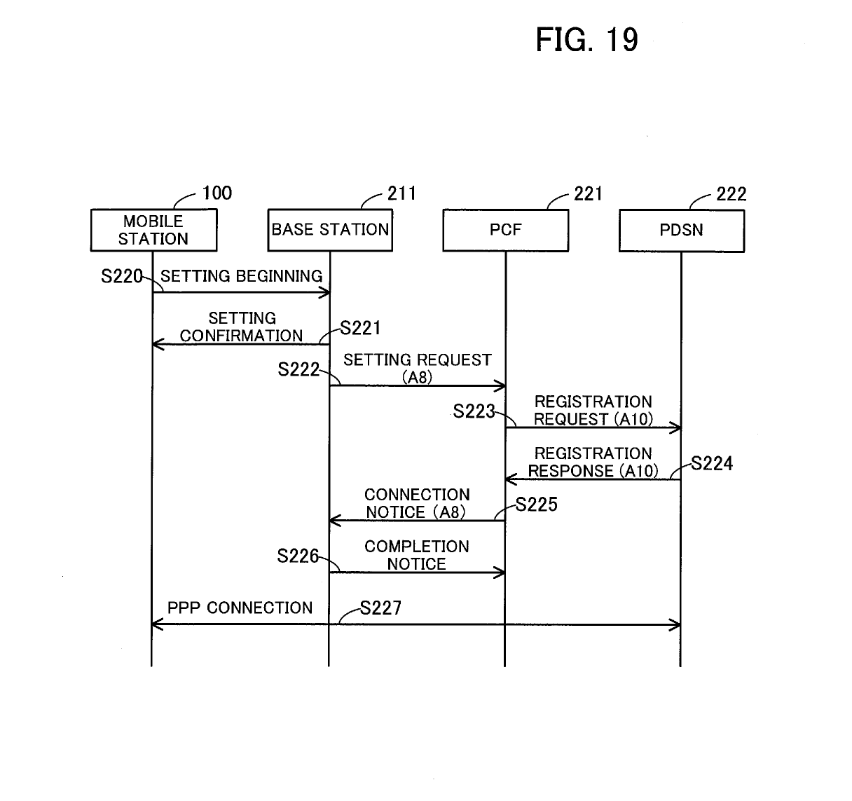

FIG. 19 is a sequence diagram of an example of a PPP connection. FIG. 19 indicates the detailed sequence of establishing a PPP connection in step S211. The details of PPP are also described in RFC (Request for Comment) 1661.

The mobile station 100 requests the base station 211 through the traffic channel to begin to set a PPP connection (step S220). The base station 211 transmits a setting beginning confirmation response to the mobile station 100 (step S221). The base station 211 establishes an A8 connection to the PCF 221 and transmits a setting request to the PCF 221 via the A8 connection (step S222). The PCF 221 establishes an A10 connection to the PDSN 222 and transmits a registration request to the PDSN 222 via the A10 connection (step S223).

The PDSN 222 transmits a registration response to the PCF 221 (step S224). The PCF 221 transmits connection notice to the base station 211 (step S225). The base station 211 transmits completion notice to the PCF 221 (step S226). As a result, the mobile station 100 can communicate with the PDSN 222 via the base station 211 and the PCF 221. The mobile station 100 sets a PPP connection to the PDSN 222 (step S227).

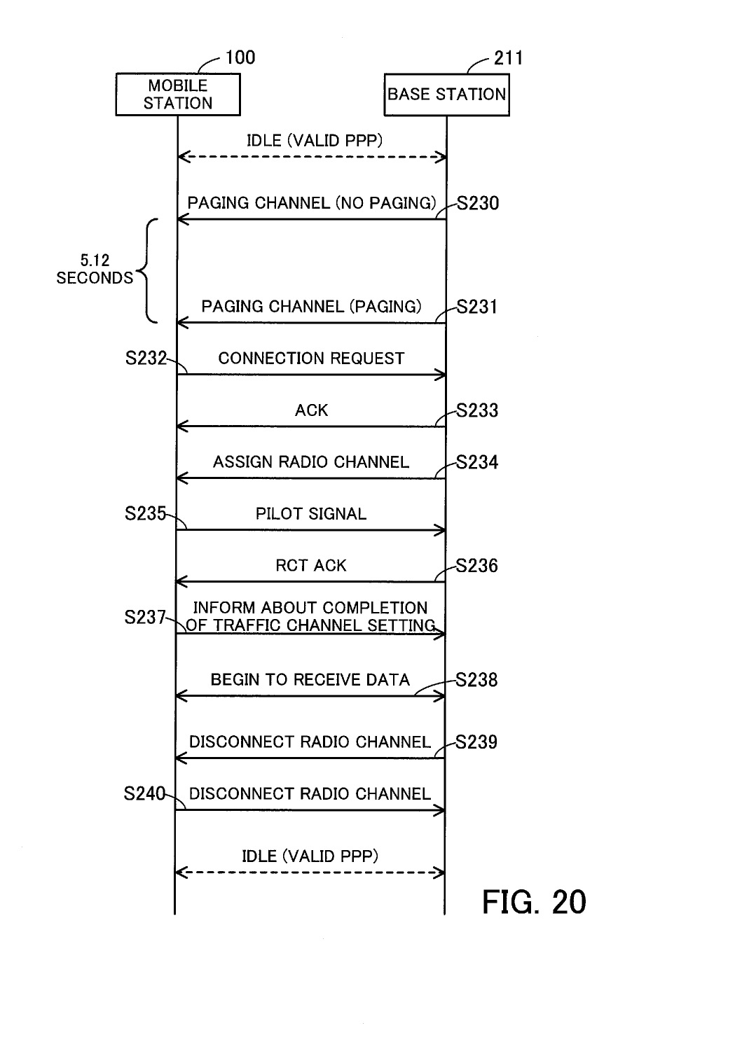

FIG. 20 is a sequence diagram of an example of receiving another paging channel. FIG. 20 indicates a case where a data channel is set in the radio access network 220 (EVDO) and where the mobile station 100 receives a paging channel from the radio access network 220. The sequence indicated in FIG. 20 is performed after, for example, the above step S17.

The base station 211 periodically transmits a paging channel. The mobile station 100 receives a paging channel in a determined cycle (5.12-second cycle, for example) and determines whether or not there is paging a destination of which is the mobile station 100. If there is no paging a destination of which is the mobile station 100, then the mobile station 100 stops processing a signal received from the radio access network 220 until timing at which the mobile station 100 receives a paging channel next (step S230).

When the mobile station 100 detects paging thereto (step S231), the mobile station 100 transmits a connection request to the base station 211 (step S232). When the base station 211 detects the connection request from the mobile station 100, the base station 211 transmits an ACK to the mobile station 100 (step S233).

The base station 211 assigns a traffic channel to the mobile station 100 and informs the mobile station 100 about the traffic channel assignment (step S234). The mobile station 100 transmits a pilot signal for the traffic channel assigned by the base station 211 (step S235). The base station 211 checks on the basis of the pilot signal received from the mobile station 100 that there is no problem about the communication quality of the traffic channel assigned to the mobile station 100, and transmits an RCT (Radio Conformance Test) ACK to the mobile station 100 (step S236). The mobile station 100 informs the base station 211 about the completion of traffic channel setting (step S237).

The mobile station 100 begins to receive data from the base station 211 (step S238). At this time a PPP connection has already been established. Accordingly, data communication can be begun immediately after the establishment of the radio channel. When the base station 211 completes transmitting data to the mobile station 100, the base station 211 gives the mobile station 100 notice of radio channel disconnection (step S239). The mobile station 100 disconnects the radio channel to respond to the notice transmitted from the base station 211 (step S240). However, the PPP connection is maintained. As a result, the mobile station 100 makes a transition again to the state “idle (valid PPP)”.

With the mobile telecommunication system according to the second embodiment the movement of the mobile station 100 to the outside of the coverage area of the radio access network 230 (WiMAX) may be detected while the CPU 101 is in the suspend state. At this time the suspend state of the CPU 101 is released. The CPU 101 is then used for establishing a PPP connection to the radio access network 220 (EVDO). As a result, a data channel set in the radio access network 230 is switched to the radio access network 220 and the mobile station 100 can receive from the radio access network 220 paging information a destination of which is the mobile station 100.

Furthermore, the PPP connection is maintained after data channel switching. Accordingly, there is no need for the mobile station 100 to carry out a PPP connection establishment procedure after receiving paging from the radio access network 220. As a result, overhead before the beginning of data communication can be reduced. In addition, even after the PPP connection is established, a search for a base station in the radio access network 230 may be continued. By doing so, data communication can be performed by the use of the high-speed broadband radio access network 230 when the mobile station 100 returns to the coverage area of the radio access network 230.

As stated above, the communication control method according to the second embodiment can be applied to another kind of radio access network. For example, an LTE radio access network may be used in place of the WiMAX radio access network 230.

According to the above embodiments a data channel for receiving paging regarding data communication can be secured.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A mobile communication apparatus which is capable of performing data communication by use of a first radio access network and a second radio access network, the apparatus comprising:
a receiving section which processes a signal received from the first radio access network; and
a control section including a processor which is capable of shifting to a suspend state,
wherein:
the receiving section releases the suspend state of the processor at the time of detecting during time for which the processor is in the suspend state that the mobile communication apparatus moves out of a coverage area of the first radio access network; and
the control section establishes a connection to the second radio access network by use of the processor at the time of the suspend state of the processor being released as a result of detecting that the mobile communication apparatus moves out of the coverage area of the first radio access network.

2. The mobile communication apparatus according to claim 1, wherein after the connection to the second radio access network is established, the processor returns to the suspend state.

3. The mobile communication apparatus according to claim 1, wherein the receiving section releases the suspend state of the processor by transmitting an interrupt signal to the processor.

4. The mobile communication apparatus according to claim 1, wherein the connection established to the second radio access network is a PPP (Point-to-Point Protocol) connection.

5. A radio communication method to be executed by a mobile communication apparatus including a processor, the mobile communication apparatus being capable of performing data communication by use of a first radio access network and a second radio access network, the method comprising:
making the processor shift to a suspend state at the time of data communication not being performed;
releasing the suspend state of the processor, on the basis of conditions under which a signal is received from the first radio access network, at the time of detecting that the mobile communication apparatus moves out of a coverage area of the first radio access network; and
establishing a connection to the second radio access network by use of the processor at the time of the suspend state of the processor being released as a result of detecting that the mobile communication apparatus moves out of the coverage area of the first radio access network.
